(19) United States
(12) Patent Application Publication
(10) Pub. No.: US 2023/0412003 A1
(43) Pub. Date: Dec. 21, 2023

(54) WIRELESS ENERGY TRANSFER FROM NETWORK NODE TO USER EQUIPMENT BASED ON PREDICTIONS

(71) Applicant: Telefonaktiebolaget LM Ericsson (publ), Stockholm (SE)

(72) Inventors: Hamed FARHADI, Stockholm (SE); Nafiseh SHARIATI, Stockholm (SE); Henrik RYDÉN, Stockholm (SE)

(21) Appl. No.: 18/035,557

(22) PCT Filed: Nov. 9, 2020
(86) PCT No.: PCT/SE2020/051078

§ 371 Date: May 5, 2023

(51) Int. Cl. H02J 50/20; H02J 50/80

(52) U.S. Cl. CPC H02J 50/20; H02J 50/80

(57) ABSTRACT

There is provided mechanisms for wireless energy transfer to a user equipment. A method is performed by a network node. The method includes configuring energy transfer to the user equipment as a function of a prediction of energy properties of the user equipment served by the network node and of properties for wireless communication with the user equipment. The method includes wirelessly transferring energy to the user equipment in accordance with the configured energy transfer.

### TECHNICAL FIELD

Embodiments presented herein relate to a method, a network node, a computer program, and a computer program product for wireless energy transfer to a user equipment. Embodiments presented herein further relate to a method, a user equipment, a computer program, and a computer program product for wireless energy reception.

### BACKGROUND

The emergence of Internet of things (IoT) will allow the deployment of a wide range of communication devices, such as low-power and/or low-cost IoT devices. In order for these communication devices not to consume a prohibitively large amount of energy, the demands for reducing power requirements for communication devices therefore are increasing. This also causes the demands for efficient energy transfer to such communication devices to increase.

Wireless energy transfer technologies could provide an efficient way of charging geographically widespread communication devices. This would enable sustainable, long battery-life, and energy-efficient operation of the communication devices. For example, wireless energy transfer might enable provisioning of energy to the communication devices. It is envisioned that network infrastructure, such as network nodes, could in addition to enabling data transmission also be used for transferring energy to the communication devices. The communication devices could thereby harvest part or all of their required energy from wirelessly transmitted radio frequency signals.

A typical energy-harvester, as could be used at the communication devices, is composed of a rectifying circuit, a lowpass filter and an energy storage device (e.g. capacitors) that converts radio frequency power to stored energy. Further, due to practical limitations, a wireless receiver cannot harvest energy from a signal intended for decoding. Hence, decoupling between the processes of signal decoding and energy harvesting is required at the communication devices.

Further, existing techniques for wireless energy transfer over networks suffer from low efficiency as it is not a priori known which communication devices require energy and when in time each communication device requires energy. It might also not be known when energy transfer should be prioritized over data transmission. Obtaining this information, and adapting the energy transfer accordingly, consumes energy, and thus reduces system efficiency.

Hence, there is still a need for improved techniques for wireless energy transfer over networks.

### SUMMARY

An object of embodiments herein is to provide wireless energy transfer over networks so that the above noted issues can be avoided, or at least reduced or mitigated.

According to a first aspect there is presented a method for wireless energy transfer to a user equipment. The method is performed by a network node. The method comprises configuring energy transfer to the user equipment as a function of a prediction of energy properties of the user equipment served by the network node and of properties for wireless communication with the user equipment. The method comprises wirelessly transferring energy to the user equipment in accordance with the configured energy transfer.

According to a second aspect there is presented a network node for wireless energy transfer to a user equipment. The network node comprises processing circuitry. The processing circuitry is configured to cause the network node to configure energy transfer to the user equipment as a function of a prediction of energy properties of the user equipment served by the network node and of properties for wireless communication with the user equipment. The processing circuitry is configured to cause the network node to wirelessly transfer energy to the user equipment in accordance with the configured energy transfer.

According to a third aspect there is presented a network node for wireless energy transfer to a user equipment. The network node comprises a configure module configured to configure energy transfer to the user equipment as a function of a prediction of energy properties of the user equipment served by the network node and of properties for wireless communication with the user equipment. The network node comprises a transfer module configured to wirelessly transfer energy to the user equipment in accordance with the configured energy transfer.

According to a fourth aspect there is presented a computer program for wireless energy transfer to a user equipment. The computer program comprises computer program code which, when run on processing circuitry of a network node, causes the network node to perform a method according to the first aspect.

According to a fifth aspect there is presented a method for wireless energy reception. The method is performed by a user equipment. The method comprises obtaining a prediction of energy properties of the user equipment and of properties for wireless communication with a network node serving the user equipment. The method comprises sending the prediction to the network node. The method comprises wirelessly receiving an energy transfer from the network node, wherein the energy transfer is configured as a function of the prediction.

According to a sixth aspect there is presented a user equipment for wireless energy reception. The user equipment comprises processing circuitry. The processing circuitry is configured to cause the user equipment to obtain a prediction of energy properties of the user equipment and of properties for wireless communication with a network node serving the user equipment. The processing circuitry is configured to cause the user equipment to send the prediction to the network node. The processing circuitry is configured to cause the user equipment to wirelessly receive an energy transfer from the network node, wherein the energy transfer is configured as a function of the prediction.

According to a seventh aspect there is presented a user equipment for wireless energy reception. The user equipment comprises an obtain module configured to obtain a prediction of energy properties of the user equipment and of properties for wireless communication with a network node serving the user equipment. The user equipment comprises a send module configured to send the prediction to the network node. The user equipment comprises a receive module configured to wirelessly receive an energy transfer from the network node, wherein the energy transfer is configured as a function of the prediction.

According to an eighth aspect there is presented a computer program for wireless energy reception, the computer program comprising computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient wireless energy transfer over networks where the above noted issues are avoided.

Advantageously, these aspects enable the overall energy transmission efficiency to be increased from a system perspective thanks to exploiting prior knowledge and prediction models, which enable energy to be transferred only when needed.

Advantageously, these aspects enable the energy consumption at the user equipment to be reduced since the user equipment can be configured to only receives energy when needed, hence prolonging the battery life.

Advantageously, these aspects enable the resources that are required for the signaling of the energy transfer to be reduced since energy is transferred only when needed.

Advantageously, these aspects enable interference to be reduced by avoiding energy transfer when and where it is not needed.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise.

The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a wireless communication system according to embodiments;

FIGS. 2 and 4 are flowcharts of methods according to embodiments;

FIG. 3 is a schematic block diagram of a network node according to embodiments;

FIG. 5 is a schematic block diagram of a user equipment according to embodiments;

FIG. 6 is a schematic block diagram of a network node and a user equipment according to embodiments;

FIG. 7 is a schematic diagram showing functional units of a network node according to an embodiment;

FIG. 8 is a schematic diagram showing functional modules of a network node according to an embodiment;

FIG. 9 is a schematic diagram showing functional units of a user equipment according to an embodiment;

FIG. 10 is a schematic diagram showing functional modules of a user equipment according to an embodiment; and

FIG. 11 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

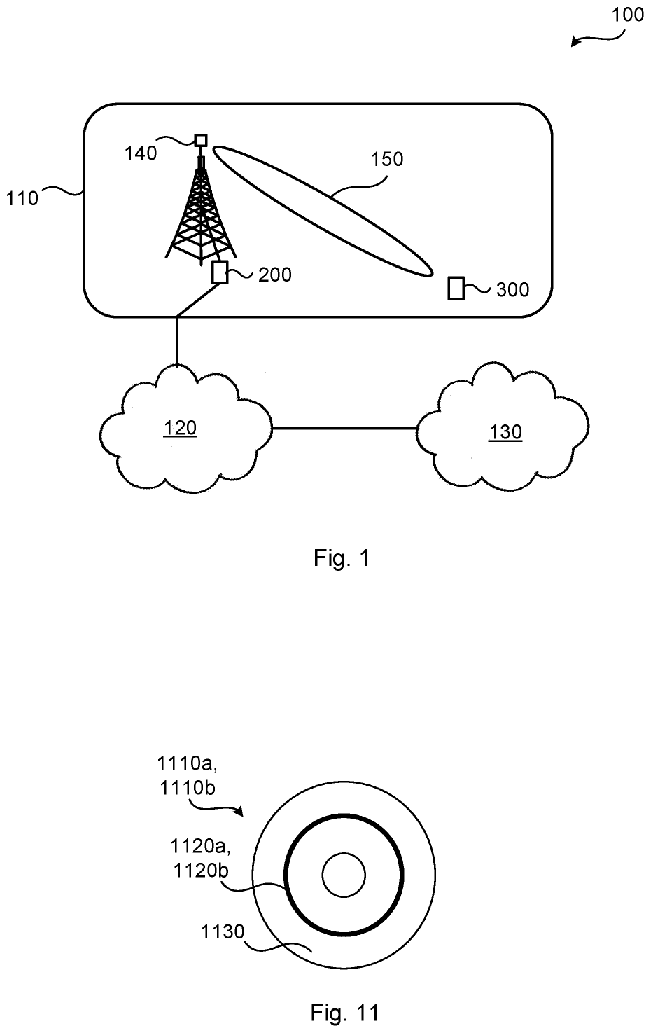

FIG. 1 is a schematic diagram illustrating a wireless communication system 100 where embodiments presented herein can be applied. The wireless communication system 100 could be a third generation (3G) telecommunications network, a fourth generation (4G) telecommunications network, a fifth generation (5G) telecommunications network, or any evolvement thereof, and support any 3GPP telecommunications standard, where applicable.

The wireless communication system 100 comprises a network node 200 configured to provide network access to user equipment, as represented by user equipment 300, in a (radio) access network 110. The (radio) access network 110 is operatively connected to a core network 120. The core network 120 is in turn operatively connected to a service network 130, such as the Internet. The user equipment 300 is thereby enabled to, via the network node 200, access services of, and exchange data with, the service network 130.

Examples of network nodes 200 are radio base stations, base transceiver stations, Node Bs, evolved Node Bs, g NBs, access points, access nodes, and integrated access and backhaul nodes. Examples of user equipment 300 are wireless devices, terminal devices, mobile stations, mobile phones, handsets, wireless local loop phones, smartphones, laptop computers, tablet computers, network equipped sensors, network equipped vehicles, wearable communication devices, and so-called Internet of Things devices.

The network node 300 comprises, is collocated with, is integrated with, or is in operational communications with, one or more transmission and reception points (TRPs) 140. The network node 200 (via its (one or more TRPs 140) and the user equipment 300 might be configured to communicate with each other in beams, one of which is illustrated at reference numeral 150. In this respect, beams that could be used both as transmit beams and receive beams will hereinafter simply be referred to as beams.

The embodiments disclosed herein relate to mechanisms for wireless energy transfer to the user equipment 300 and for wireless energy reception at the user equipment 300. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a user equipment 300, a method performed by the user equipment 300, and a computer program product comprising code, for example in the form of a computer program, that when run on processing circuitry of the user equipment 300, causes the user equipment 300 to perform the method.

The term wireless energy transfer as used in this disclosure refers to transfer of electrical energy by means of electromagnetic wave radiation from a transmitter device. In a non-limiting example, for the transmitter device to perform wireless energy transfer, a signal at a frequency or a frequency band is generated, and a power amplifier converts direct current (DC) power (e.g. from a battery or an energy supplier unit at the transmitter device) to alternating current (AC) power by boosting the power of the input signal. The thus amplified signals are fed to an antenna or antenna array for propagation, in the form of electromagnetic waves, through a wireless propagation medium.

A receiver device can partially absorb the thus wirelessly transferred energy and partially reflect the energy, e.g. in the form of back scattering. The absorbed energy at the receiver device might either be directly consumed by electronic circuits at the receiver device, or be stored for future use e.g. by charging a capacitor (for short-term storage) or by charging a battery (for long-term storage). In this process, part of the energy might be scattered or transformed to heat at the transmitter device, the receiver device, and the wireless propagation medium.

The term power generally refers to the rate at which energy is transmitted, received, or generated. Thus the maximum amount of power for a receiver, transmitter, or generator (e.g. a battery) to handle depends on the maximum amount of energy that can be transmitted, received, or generated per unit of time. The maximum amount of energy that a transmitter device can send in general terms depends on the energy budget of the transmitter device (e.g. battery capacity if the battery energy is transferred). The maximum amount of energy that the receiver device can store depends on the storage capacity of the device (e.g. the capacity of a battery to be charged, or the capacity of a capacitor to be charged). However, the terms power and energy can be used interchangeably, so that the terms wireless power charging, wireless energy transfer, wireless charging, wireless power transfer, etc. are all referring to the same concept.

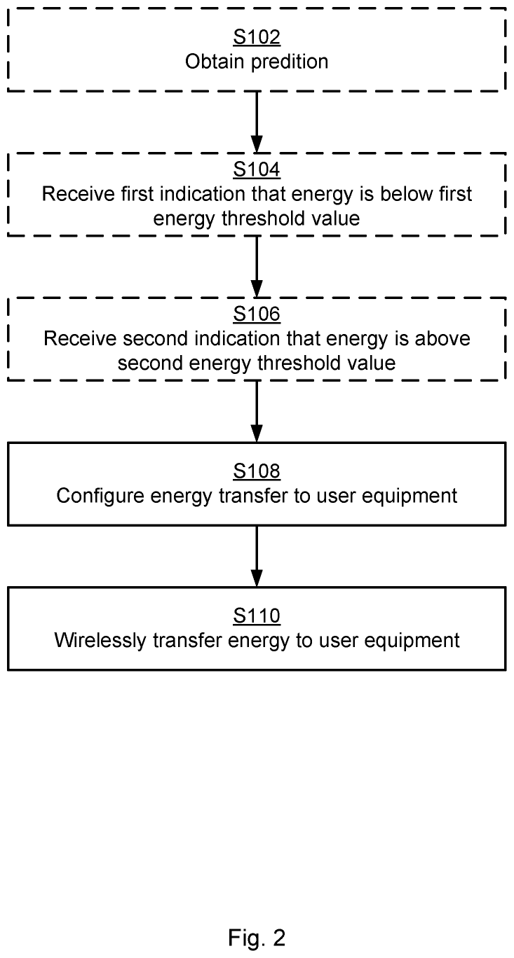

Reference is now made to FIG. 2 illustrating a method for wireless energy transfer to the user equipment 300 as performed by the network node 200 according to an embodiment.

The methods are based on that the network node 200 configure energy transfer to the user equipment 300 according to predictions, as in action S108.

S108: The network node 200 configures energy transfer to the user equipment 300. The energy transfer is configured as a function of a prediction of energy properties of the user equipment 300 served by the network node 200 and of properties for wireless communication with the user equipment 300. Examples of energy properties as well as examples of properties for wireless communication will be disclosed below.

The energy is then wirelessly transferred to the user equipment 300, as in action S110.

S110: The network node 200 wirelessly transfers energy to the user equipment 300 in accordance with the configured energy transfer. The energy is thus wirelessly transferred to the user equipment 300.

Embodiments relating to further details of wireless energy transfer to a user equipment 300 as performed by the network node 200 will now be disclosed.

As disclosed above, the energy transfer is configured as a function of a prediction. This prediction might thus be obtained by the network node 200. Hence, according to some embodiments, the network node 200 is configured to perform (optional) action S102:

S102: The network node 200 obtains the prediction.

Optional action S102 is performed before action S104.

There may be different ways for the network node 200 to obtain the prediction. In some aspects, the prediction is obtained by being computed by the network node 200 itself. That is, in some embodiments, the prediction is obtained by being determined by the network node 200 itself. In other aspects, the prediction is obtained from the user equipment 300. That is, in other embodiments, the prediction is obtained from the user equipment 300.

In some embodiments, the prediction is based on machine learning of at least one of: a traffic pattern of the user equipment 300, a mobility pattern of the user equipment 300. With a prediction model, the probability of data arriving in the downlink and/or uplink for the user equipment 300 can be predicted. The prediction could, for example, be the probability of data arriving within a time duration T, or the probability of data received within the frame from the point in time T, to the point in time T2. The prediction could be based on the history of data transmissions and/or receptions at the user equipment 300 (i.e., the traffic pattern), user equipment traffic behavior (e.g., activity and/or mobility pattern, etc.), or history of another user equipment 300. Input to such a prediction model could be at least some of the following parameters: packet inter arrival time (standard deviation value, average value, etc.) at the user equipment 300, number of packets in uplink and/or downlink for the user equipment 300, total bytes in uplink and/or downlink for the user equipment 300, Packet sizes, time since last packet transmission and/or reception for the user equipment 300, packet protocol (e.g., HTTP, VoIP, etc.) used for the packet transmission and/or reception for the user equipment 300, user equipment manufacturer. The prediction model could also be used to estimate the probability of the user equipment 300 not having the energy to receive or transmit data. The inputs to the prediction model could be user equipment related data such as historical energy information data from the user equipment 300, chipset energy consumption at the user equipment 300, the energy transmitted from the network node 200. The input could also be network related data, such as environment characteristics (e.g., if the network is deployed in a dense environment, such as a dense urban city, the user equipment 300 is more likely to have energy to harvest), historical energy information from other pieces of user equipment. The user equipment 300 can be scheduled for energy transfer based on the predicted traffic for the user equipment 300 and the predicted energy status of the user equipment 300, where the portion of transmitted energy toward the user equipment 300 can be optimized based on the predicted traffic load and predicted energy status of the user equipment 300. For instance, more energy is transmitted if the energy is predicted to be low and/or if the traffic is predicted to be high than if the energy is predicated to be high and/or if the traffic is predicted to be low.

Further, before the prediction model can be used, it needs to be trained with data. This could be achieved by collecting data from a real or a simulated network, thus learning, based on certain inputs, whether a user equipment has energy for transmission when data is expected to arrive (in the downlink and/or uplink).

In some embodiments, the traffic pattern is a predicted traffic pattern of the user equipment 300 and/or is received from the user equipment 300. For example, the user equipment 300 might in addition to signal its energy consumption to the network node 200, signal its predicted traffic to the network node 200. In some embodiments, the energy transfer further is configured as a function of at least one of: energy information status of the user equipment 300 as received from the user equipment 300, traffic information of the user equipment 300 as received from the user equipment 300. In some aspects, the prediction is updated. In particular, in some embodiments, the prediction is updated based on the energy information status of the user equipment 300, and/or the traffic information of the user equipment 300.

In some aspects, the user equipment 300 is configured to signal its predicted future traffic when its energy is lower than a threshold to the network node 200. The network node 200 might then transfer energy to the user equipment 300 before the next data will be sent by the user equipment 300. In some aspects, the user equipment 300 is configured to signal to the network node 200 that the user equipment 300 is in need of energy. In particular, in some embodiments, the network node 200 is configured to perform (optional) action S104:

S104: The network node 200 receives a first indicator from the user equipment 300 that an energy level in the user equipment 300 is below a first energy threshold value. The energy transfer is then further configured based on the first indicator.

The first indicator might be a flag. The user equipment 300 might thus send a flag signal when its energy level is lower than the first energy threshold value and it is required to harvest energy. The flag can also indicate a future time instance when the user equipment 300 is predicted to have no energy left. For example, the user equipment 300 might indicate that its next uplink packet will arrive in 24 hours, and the network node 200 might then transfer energy to the user equipment 300 prior to these 24 hours. Such an indication from the user equipment 300 might comprise a set of time windows, and associated probability values, where the probability values might describe the likelihood in traffic arrival (or no traffic arrival) in each time window. The flag can be transmitted over a reserved resource block or transmission time interval (TTI) and the network node 200 might then monitor received signals over the reserved resource block or TTI. If the flag is detected at the network node 200, then the network node 200 might trigger the transfer of energy to the user equipment 300. In general terms, the energy is transferred over certain resource blocks or TTIs, and the number of resource blocks or TTIs can be adapted, for example, based on how frequently the flag is detected. Further, the predictive model could be trained to predict the energy level at the user equipment 300 based on the time intervals over which consecutive flags were detected.

In other aspects, the user equipment 300 signals to the network node 200 that the user equipment 300 is not in need of energy. In particular, in some embodiments, the network node 200 is configured to perform (optional) action S106:

S106: The network node 200 receives a second indicator from the user equipment that an energy level in the user equipment 300 is above a second energy threshold value. The energy transfer further is configured based on the second indicator.

The second indicator might be a flag. The user equipment 300 might thus send a flag signal when its energy level is larger than the second energy threshold value and the user equipment 300 does not need to be charged. The flag can be transmitted over a reserved resource block or transmission time interval (TTI) and the network node 200 might then monitor received signals over the reserved resource block or TTI. If the flag is detected at the network node 200, then the network node 200 might stop the transfer of energy for a certain period of time, where the period over which the energy transmission is stopped can be adapted, for example, based on how frequently the energy flag is detected. In general terms, the energy is transferred over certain resource blocks or TTIs, and the number of resource blocks or TTIs can be adapted, for example, based on how frequently the flag is detected. Further, the predictive model could be trained to predict the energy level at the user equipment 300 based on the time intervals over which consecutive flags were detected. Using this approach, the flag is transmitted only when the user equipment 300 is sufficiently charged and is not energy constrained.

In some embodiments, the energy properties of the user equipment 300 pertain to at least one of: remaining energy of the user equipment 300, expected energy needed by the user equipment 300 to communicate a packet with the network node 200. In some embodiments, the properties for wireless communication pertain to at least one of: time to next communication of a packet with the user equipment 300, size of the packet. In some embodiments, the energy transfer is configured to start at time t and to stop at time t+τ, wherein τ depends on at least one of: size of the packet, whether the packet is communicated to the user equipment 300 from the network node 200 or from the user equipment 300 to the network node 200.

In general terms, to perform joint data communication and energy transfer, the network node 200 might transmit a combination of information signals and energy signals and the user equipment 300 might try to decode the information signal and harvest the energy from the energy signal. To improve the performance of a data communication system, or the efficiency of an energy transfer system, an antenna system with multiple individual antenna elements can be used at the transmitter side (i.e., at the network node side) to beamform the transmitted signals towards the intended receiver at the user equipment 300. This could improve, for example, the received signal-to-noise (SNR) ratio at the receiver and increases the amount of the energy which is received at the receiver. Hence, in some aspects, the energy transfer is beamformed towards the user equipment 300. Thus, in some embodiments, the energy is transferred in a directional beam 150, wherein the directional beam 150 has a power pattern determined by precoding weights.

In some aspects, the energy transfer is beamformed towards the user equipment 300 using channel state information (CSI) acquired from the user equipment 300. Thus, in some embodiments, the precoding weights have values that depend on channel state information as received from the user equipment 300. The CSI acquisition can be performed based on downlink channel estimation and feedback from the user equipment 300 (e.g., transmission of downlink reference signals from the network node 200 and measurement reports of the downlink reference signals as transmitted by the user equipment 300). In this respect, the user equipment 300 might be configured to send the index of quantized CSI values, or the code of compressed CSI values using autoencoder. That is, in some embodiments, the channel state information as received from the user equipment 300 is an index to quantized channel state information or is encoded, or compressed, channel state information. An estimate of the CSI can then be reconstructed at the network node 200. Alternatively, the CSI acquisition can be performed based on uplink channel estimation and exploiting uplink/downlink reciprocity (e.g., transmission of uplink reference signals from the user equipment 300 and measurements of the uplink reference signals as performed by the network node 200).

In some aspects, several pieces of user equipment 300 are co-located in the same area (i.e. have correlated CSI) or have similar spatial characteristics. Such pieces of user equipment 300 might share the same beam and thus reduce the resources needed for CSI acquisition. In particular, in some embodiments, the user equipment 300 is a first user equipment 300 that is co-located with at least one second user equipment 300, and the energy is transferred in one and the same directional beam 150 towards the first user equipment 300 and the at least one second user equipment 300. In this respect, several pieces of user equipment 300 might be clustered based on their CSI characteristics such that pieces of user equipment 300 that have similar CSI values fall in one and the same cluster. The clustering can be performed based parameters such as historical CSI measurements, user equipment locations, etc. Pieces of user equipment 300 might thus be assigned to the same cluster such that a metric that measure the difference between different CSI values is minimized. One user equipment 300 can be selected as the representative of the cluster for which the CSI acquisition is conducted. The beamforming of the energy signal toward the pieces of user equipment 300 within each cluster might then be computed based on the measured CSI for the representative user equipment 300 of the cluster.

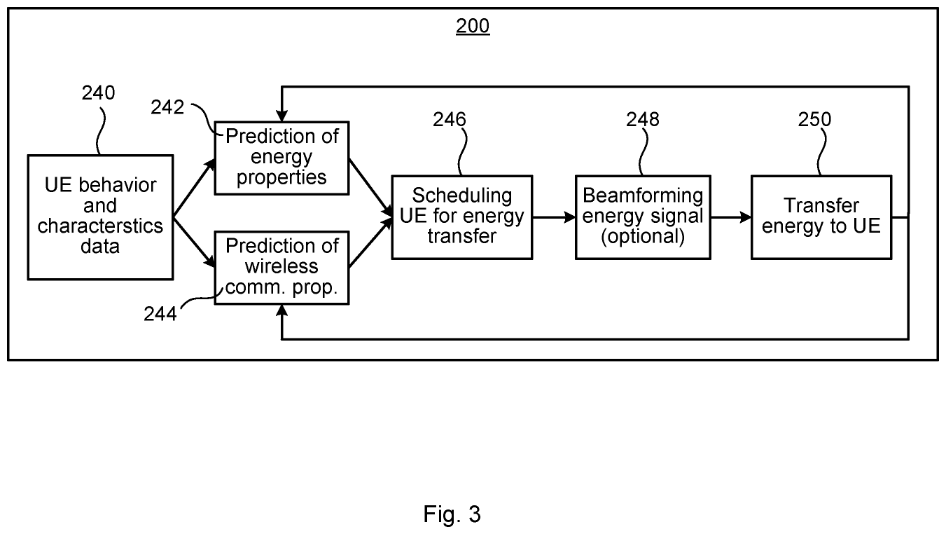

Reference is now made to FIG. 3 illustrating a block diagram of the network node 200 according to an embodiment. The network node 200 comprises a data acquire block 240 configured to acquire information from the user equipment 300 as in actions S102, S104, S106, a first prediction block 242 configured to predict the energy properties of the user equipment 300, a second prediction block 244 configured to predict the properties for wireless communication with the user equipment 300, a scheduling block 246 configured to configure the energy transfer as in action S108, a beamforming block 248 configured to determine the precoder weights for beamforming, and a transfer block 250 configured to transfer energy to the user equipment 300 as in action S110. In some examples, blocks 242 and 244 are combined into a single prediction block.

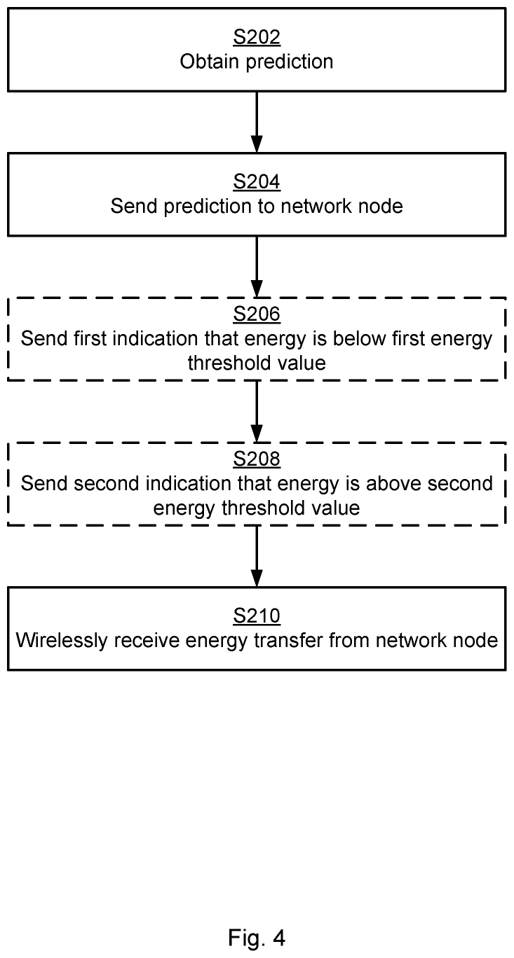

Reference is now made to FIG. 4 illustrating a method for wireless energy reception as performed by the user equipment 300 according to an embodiment.

As disclosed above, in some aspects, the prediction of energy properties of the user equipment 300 and of properties for wireless communication with a network node 200 serving the user equipment 300 is determined by the user equipment 300.

S202: The user equipment 300 obtains a prediction of energy properties of the user equipment 300 and of properties for wireless communication with the network node 200 serving the user equipment 300.

The prediction is signalled to the network node 200, as in action S204.

S204: The user equipment 300 sends the prediction to the network node 200.

As disclosed above, the network node 200 transfers energy to the user equipment in accordance with a configured energy transfer, where the energy transfer is configured as function of the prediction.

S210: The user equipment 300 wirelessly receives an energy transfer from the network node 200. The energy transfer is configured as a function of the prediction. The energy transfer is thus wirelessly received.

The user equipment 300 might in addition to signalling its own energy consumption, signal its predicted traffic to the network node 200. The prediction might thus be performed at the user equipment 300.

Embodiments relating to further details of wireless energy reception at the user equipment 300 as performed by the user equipment 300 will now be disclosed.

In general terms, the embodiments, aspects, and examples, as disclosed above with reference to the network node 200 are also applicable to the user equipment 300. For completeness of this disclosure the embodiments as well as some of the aspects and examples are repeated hereinafter. However, a repeated description of all details is omitted to avoid unnecessary repetition in this disclosure.

As disclosed above, in some embodiments, the prediction is based on machine learning of at least one of: a traffic pattern of the user equipment 300, a mobility pattern of the user equipment 300. As further disclosed above, in some embodiments, the traffic pattern is a predicted traffic pattern of the user equipment 300. As further disclosed above, in some embodiments, the prediction is updated based on at least one of: energy information status of the user equipment 300, traffic information of the user equipment 300.

As disclosed above, in some embodiments, the energy is received in a directional beam 150, wherein the directional beam 150 has a power pattern determined by precoding weights. As further disclosed above, in some embodiments, the precoding weights have values that depend on channel state information as sent from the user equipment 300 to the network node 200. As further disclosed above, in some embodiments, the channel state information is sent from the user equipment 300 as an index to quantized channel state information or as encoded, or compressed, channel state information. Further, in some embodiments, the channel state information is adaptively sent from the user equipment 300 based on at least one of: predicted mobility of the user equipment 300, rate at which channel measurements on which the channel state information is based changes.

As disclosed above, in some embodiments, the energy properties of the user equipment 300 pertain to at least one of: remaining energy of the user equipment 300, expected energy needed by the user equipment 300 to communicate a packet with the network node 200. As further disclosed above, in some embodiments, the properties for wireless communication pertain to at least one of: time to next communication of a packet with the network node 200, size of the packet.

As disclosed above, in some aspects, the user equipment 300 is configured to signal its predicted future traffic when its energy is lower than a threshold to the network node 200. In particular, in some embodiments, the user equipment 300 is configured to perform (optional) action S206:

S206: The user equipment 300 sends a first indicator to the network node 200 that an energy level in the user equipment 300 is below a first energy threshold value.

As further disclosed above, in other aspects, the user equipment 300 signals to the network node 200 that the user equipment 300 is not in need of energy. In particular, in some embodiments, the user equipment 300 is configured to perform (optional) action S208:

S208: The user equipment 300 sends a second indicator to the network node 200 that an energy level in the user equipment 300 is above a second energy threshold value.

In some embodiments, the user equipment 300 receives periodic energy transfers from the network node 200, and the user equipment 300 switches to an energy harvest mode of operation in-between two adjacent periodic energy transfers. The user equipment 300 might thus switch to a legacy energy harvesting mode (e.g., due to lack of sufficient energy to send the first indicator), when the network node 200 transfers energy with a fixed periodicity over preconfigured resource blocks or TTIs.

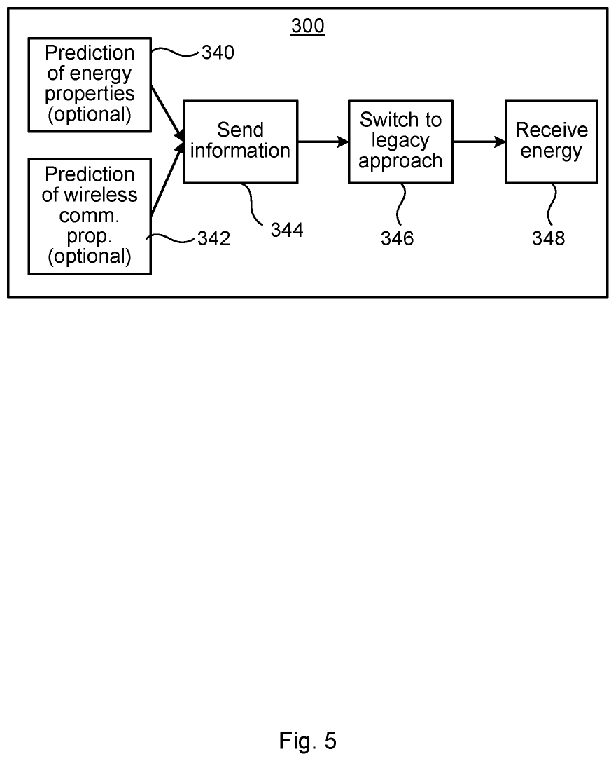

Reference is now made to FIG. 5 illustrating a block diagram of the user equipment according to an embodiment. The user equipment 300 comprises a first prediction block 340 configured to predict the energy properties of the user equipment 300 as in action S202, a second prediction block 342 configured to predict the properties for wireless communication with the network node 200 as in action S202, a send information block 344 configured to send information as in actions S204, S206, and S208, a switch block 346 configured to switch to the legacy energy harvesting mode, and a receive energy block 348 configured to receive the energy transfer as in action S210. In some examples, blocks 340 and 342 are combined into a single prediction block.

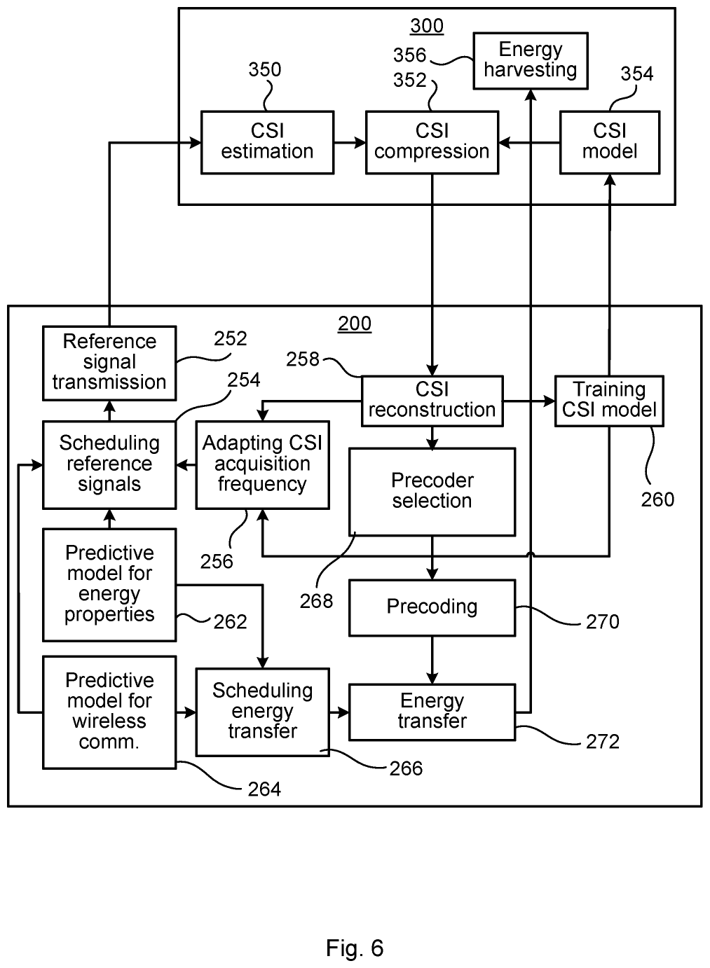

Reference is now made to FIG. 6 illustrating a block diagram of the network node 200 and the user equipment 300 according to an embodiment where the prediction is performed at the network node 200.

Blocks of the network node 200 will now be described. A reference signal transmission block 252 is configured to transmit reference signals towards the user equipment 300. A scheduling reference signals block 254 is configured to schedule transmission of the reference signals based in inputs from blocks 256, 258, 262, and 264. An adapting CSI acquisition frequency block 256 is configured to determine when in time (and in which direction(s) in space) the reference signals are to be transmitted. A CSI reconstruction block 258 is configured to reconstruct CSI values based on compressed CSI values as received from the user equipment 300 and provide the CSI values to blocks 256 and 260. A training CSI model block 260 is configured to provide information to the user equipment 300 relating to how the CSI values are to be sent to the network node 200 and/or when in time the CSI values are to be sent to the network node 200. A first predictive model block 262 is configured to predict energy properties of the user equipment 300. A second predictive model block 264 is configured to predict properties for wireless communication with the user equipment 300. In some examples, blocks 262 and 264 are combined into a single prediction block. A scheduling energy transfer block 266 is configured to configure, or schedule, the energy transfer to the user equipment 300 based on input from blocks 262 and 264. A precoder selection block 268 is configured to select a precoder based on the CSI value received from block 258. A precoding block 270 is configured to precode signals to be transmitted by block 272 according to the precoder selected by block 268. An energy transfer block 272 is configured to, in accordance with the scheduling of block 266, transfer energy in the precoded signal towards the user equipment 300.

Blocks of the user equipment 300 will now be described. A CSI estimation block 350 is configured to estimate CSI based on reference signals received from the network node 200. A CSI compression block 352 is configured to, based on input from blocks 350 and 354, compress, or encode, the CSI values and send the compressed, or encoded, CSI values to the network node 200. A CSI model block 354 is configured to, based on input from the training CSI model block 260, determine how the CSI values are to be sent to the network node 200 and/or when in time the CSI values are to be sent to the network node 200. An energy harvesting block 356 is configured to receive energy as transmitted by the network node 200.

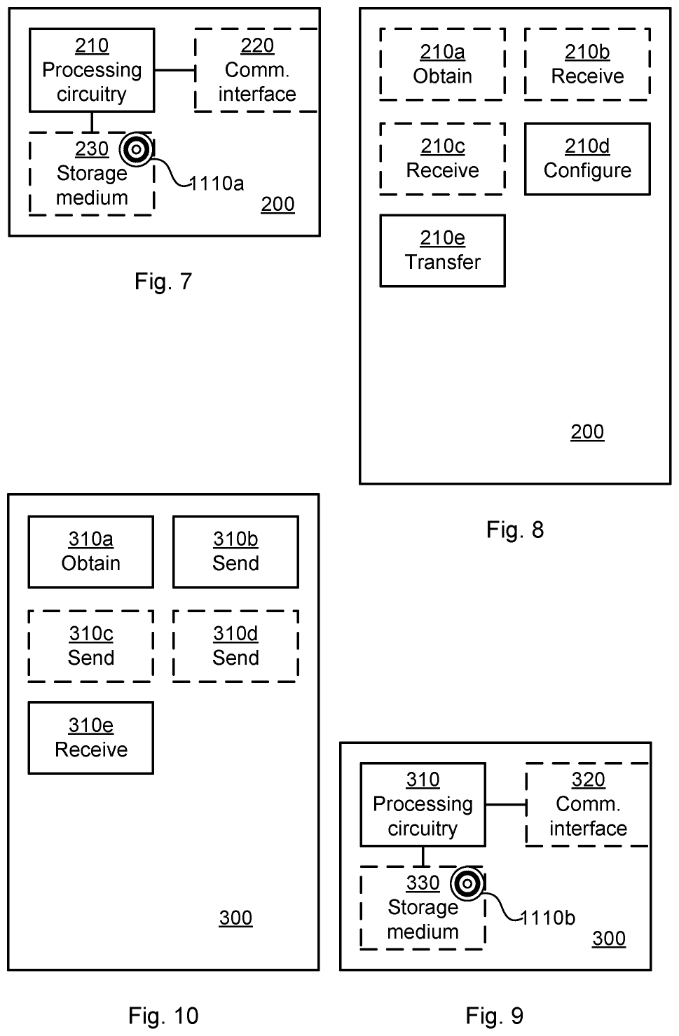

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or actions, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices, such as the user equipment 300. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230.

Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; a configure module 210d configured to perform action S108, and a transfer module 210e configured to perform action S110. The network node 200 of FIG. 8 may further comprise a number of optional functional modules, such as any of an obtain module 210a configured to perform action S102, a receive module 210b configured to perform action S104, and a receive module 210C configured to perform action S106. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any actions of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed user equipment 300 may reside in the radio access network, such as in the radio access network node.

Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210, 310 is illustrated in FIG. 7 the processing circuitry 210 may be distributed among a plurality of devices, or nodes. The same applies to the functional modules 210a:210e of FIG. 8 and the computer program 1120a of FIG. 11.

FIG. 9 schematically illustrates, in terms of a number of functional units, the components of a user equipment 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product mob (as in FIG. 11), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300 to perform a set of operations, or actions, as disclosed above. For example, the storage medium 330 may store the set of operations, and the processing circuitry 310 may be configured to retrieve the set of operations from the storage medium 330 to cause the user equipment 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300 may further comprise a communications interface 320 for communications with other entities, functions, nodes, and devices, such as the network node 200. As such the communications interface 320 may comprise one or more transmitters and receivers, comprising analogue and digital components.

The processing circuitry 310 controls the general operation of the user equipment 300 e.g. by sending data and control signals to the communications interface 320 and the storage medium 330, by receiving data and reports from the communications interface 320, and by retrieving data and instructions from the storage medium 330. Other components, as well as the related functionality, of the user equipment 300 are omitted in order not to obscure the concepts presented herein.

FIG. 10 schematically illustrates, in terms of a number of functional modules, the components of a user equipment 300 according to an embodiment. The user equipment 300 of FIG. 10 comprises a number of functional modules; an obtain module 310a configured to perform action S202, a send module 310b configured to perform action S204, and a receive module 310e configured to perform action S310. The user equipment 300 of FIG. 10 may further comprise a number of optional functional modules, such as any of a send module 310c configured to perform action S206, and a send module 310d configured to perform action S208. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any actions of the user equipment 300 as disclosed herein.

FIG. 11 shows one example of a computer program product 1110a, mob comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product moa may thus provide means for performing any actions of the network node 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product mob may thus provide means for performing any actions of the user equipment 300 as herein disclosed.

In the example of FIG. 11, the computer program product moa, mob is illustrated as an optical disc, such as a CD (compact disc) or a DVD (digital versatile disc) or a Blu-Ray disc. The computer program product moa, mob could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product moa, mob.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for wireless energy transfer to a user equipment, the method being performed by a network node, the method comprising:
configuring energy transfer to the user equipment as a function of a prediction of energy properties of the user equipment served by the network node and of properties for wireless communication with the user equipment; and
wirelessly transferring energy to the user equipment in accordance with the configured energy transfer.

2. The method according to claim 1, wherein the method further comprises:
obtaining the prediction.

3. The method according to claim 2, wherein the prediction is obtained by being determined by the network node itself.

4. The method according to claim 2, wherein the prediction is obtained from the user equipment.

5. The method according to claim 1, wherein the prediction is based on machine learning of at least one of: a traffic pattern of the user equipment or a mobility pattern of the user equipment.

6. The method according to claim 5, wherein the traffic pattern is at least one of a predicted traffic pattern of the user equipment or is received from the user equipment.

7. The method according to claim 1, wherein the energy transfer further is configured as a function of at least one of: energy information status of the user equipment as received from the user equipment or traffic information of the user equipment as received from the user equipment.

8. The method according to claim 7, wherein the prediction is updated based on at least one of the energy information status of the user equipment or the traffic information of the user equipment.

9. The method according to claim 1, wherein the energy is transferred in a directional beam, wherein the directional beam has a power pattern determined by precoding weights.

10. The method according to claim 9, wherein the precoding weights have values that depend on channel state information as received from the user equipment.

11-17. (canceled)

18. A method for wireless energy reception, the method being performed by a user equipment, the method comprising:
obtaining a prediction of energy properties of the user equipment and of properties for wireless communication with a network node serving the user equipment;
sending the prediction to the network node; and
receiving an energy transfer from the network node, wherein the energy transfer is configured as a function of the prediction.

19. The method according to claim 18, wherein the prediction is based on machine learning of at least one of: a traffic pattern of the user equipment or a mobility pattern of the user equipment.

20. The method according to claim 19, wherein the traffic pattern is a predicted traffic pattern of the user equipment.

21. The method according to claim 18, wherein the prediction is updated based on at least one of: energy information status of the user equipment or traffic information of the user equipment.

22. The method according to claim 18, wherein the energy is received in a directional beam, and wherein the directional beam has a power pattern determined by precoding weights.

23. The method according to claim 22, wherein the precoding weights have values that depend on channel state information as sent from the user equipment to the network node.

24. The method according to claim 22, wherein the channel state information is sent from the user equipment as an index to quantized channel state information or as encoded, or compressed, channel state information.

25. The method according to claim 22, wherein the channel state information is adaptively sent from the user equipment based on at least one of: predicted mobility of the user equipment or rate at which channel measurements on which the channel state information is based changes.

26. The method according to claim 18, wherein the energy properties of the user equipment pertain to at least one of: remaining energy of the user equipment or expected energy needed by the user equipment to communicate a packet with the network node.

27-33. (canceled)

34. A user equipment for wireless energy reception, the user equipment comprising processing circuitry, the processing circuitry being configured to cause the user equipment to:
determine a prediction of energy properties of the user equipment and of properties for wireless communication with a network node serving the user equipment;
send the prediction to the network node; and
wirelessly receive an energy transfer from the network node, wherein the energy transfer is configured as a function of the prediction.

35-39. (canceled)
